(19) United States
(12) Patent Application Publication
(10) Pub. No.: US 2026/0237617 A1
(43) Pub. Date: Aug. 13, 2026

(54) VACUUM PUMP

(71) Applicant: Edwards Vacuum LLC, Sanborn, NY (US)

(72) Inventor: Derek Alexander Clement, Shakopee, MN (US)

(21) Appl. No.: 19/156,702

(22) PCT Filed: Sep. 6, 2023
(86) PCT No.: PCT/IB2023/058810

§ 371 Date: Aug. 14, 2025

(30) Foreign Application Priority Data
Feb. 22, 2023 (GB) 2302521.6

(51) Int. Cl. H01J 41/20

(52) U.S. Cl. CPC H01J 41/20

(57) ABSTRACT

Vacuum pump comprising: a sputter ion pump, SIP, module, having a first end and a second end; a non-evaporable getter, NEG, module, connected to the second end of the SIP module; an electrical lead of the NEG module running from the first end to the second end of the SIP module; wherein the SIP module comprises an anode having a first surface and an opposite second surface, wherein at least on cylindric opening extends from the first surface to the second surface, wherein the anode further comprises side surfaces extending from the first surface to the second surface, wherein the electrical lead is arranged at the side surface of the anode.

### CROSS-REFERENCE TO RELATED APPLICATION

This application is a Section 371 National Stage Application of International Application No. PCT/IB2023/058810 filed Sep. 6, 2023, and published as WO 2024/175978 A1 on Aug. 29, 2024, the content of which is hereby incorporated by reference in its entirety and which claims priority of British Application No. 2302521.6, filed Feb. 22, 2023.

### BACKGROUND

The present invention relates to a vacuum pump and in particular a vacuum pump including a sputter ion pump (SIP) module and a non-evaporable getter (NEG) module.

Commonly known SIPs comprise one or more anodes built as tubes or cylindric openings wherein a magnetic field is oriented parallel to the central axis of the tubes. The anode is surrounded by cathode elements. In particular a cathode element is arranged opposite to the cylindric openings of the anode at a certain distance along the central axis. A strong electrical field is generated between the anode and the cathode. Due to the magnetic field, the path of the electrons within the anode cells are augmented which results in ionization of gas atoms and molecules in the vacuum chamber. The resulting ions are accelerated to strike the cathode element. On impact of the accelerated ions on the cathode elements, they will either become buried within the cathode material or sputter cathode material onto the other surfaces of the pump. The continuously sputtered chemical active cathode material acts as a getter which then evacuates the gas by both chemisorption and physisorption resulting in a net pumping action.

It is known in the prior art to combine an SIP with an NEG pump. The NEG module usually comprises a heater element and at least one and preferably a plurality of NEG elements arranged around the heater. By the heater element the NEG elements can be activated or reactivated during operation by heating them up.

When combining an SIP module and an NEG module, electrical connection of the heater element is necessary. Wiring requires additional space which is limited in vacuum. However, routing the electrical connections through the volume of the SIP may have the disadvantage that sputtered elements of the SIP module can reach the electrical lead of the NEG module and create shorts between the anode and grounded components of the SIP which reduces lifetime of the SIP. Thus, in the prior art usually a separated arrangement of SIP module and NEG module is used increasing the required space in the vacuum chamber.

The discussion above is merely provided for general background information and is not intended to be used as an aid in determining the scope of the claimed subject matter. The claimed subject matter is not limited to implementations that solve any or all disadvantages noted in the background.

### SUMMARY

It is an object of the present invention to provide a compact vacuum pump, which can be operated more reliable over a longer time.

The problem is solved by a vacuum pump according to claim 1.

The vacuum pump according to the present invention comprises a sputter ion pump (SIP) module having a first end and a second end. Further, the vacuum pump comprises a non-evaporable getter (NEG) module connected to the second end of the SIP module. Thus, the SIP module and the NEG module are arranged in a stacked manner to create a compact vacuum pump, which can be inserted into a vacuum chamber of a vacuum apparatus having a reduced footprint. In particular the NEG module might be directly connected to the top of the SIP module. Alternatively, the NEG module might be connected to the top of the SIP module via an intermediate element in order to facilitate connection between the NEG module and the SIP module.

According to the present invention an electric lead of the NEG module is running from the first end to the second end of the SIP module. The SIP module comprises an anode having a first surface and an opposite second surface, wherein at least one cylindric opening extends from the first surface to the second surface. The cylindric opening is considered an anode cell of the SIP module for pumping action of the SIP module. The anode further comprises side surfaces extending from the first surface to the second surface. The electrical lead of the NEG module running from the first end to the second end of the SIP module is arranged at and preferably in direct contact with the side surface of the anode. Thus, the electrical lead is integrated into the SIP module and routed through the SIP module providing a small, compact size of the vacuum pump. However, due to arranging the electrical lead at the side surface of the anode, the electrical lead is protected from being sputtered by the SIP module. Thus, the anode itself shields the electrical lead from material of the cathode elements of the SIP module being sputtered onto or close to the electrical lead. Thereby, likelihood of shorts between the anode of the SIP module and grounded components of the SIP module are reduced by preventing bridging the gap between the anode and the grounded components via the electrical lead by sputtered metal. The vacuum pump and in particular the SIP module can be operated over a longer time without failure.

Preferably, no line of sight exists between the cathode of the SIP module and the electrical lead and more specifically no line of sight exists between the projection of the anode onto the cathode and the electrical lead. A straight line could not be drawn from the diameter of the anode cell projected onto the cathode to the electrical lead without passing through another surface. This significantly reduces the likelihood of sputtered cathode material coating the electrical lead with conductive material.

Preferably, the anode of the SIP module blocks a direct line between the cathode and the electrical lead. Thus, the anode itself blocks any line of sight between the cathode and the electrical lead.

Preferably, the anode of the SIP module has a width, i. e. a distance from the first surface to the second surface or length of the respective anode cells, of between 10 mm and 50 mm, more preferably between 15 mm and 30 mm and most preferably between 15 mm 20 mm. Due to the width of the anode sufficient shielding of the electrical lead can be provided such that the material of the cathode cannot be sputtered onto the electrical lead.

Preferably, the electrical lead is arranged through the SIP module. In particular, the electrical lead is arranged through the SIP module or through the active or pumping volume of the SIP module. Thereby, a compact design of the SIP module and the overall vacuum pump can be provided by integrating the electrical lead into the outer structure or the pumping volume of the SIP module. This is possible since the electrical lead is shielded by the anode itself and material from the cathode of the SIP module has a reduced likelihood of sputtering onto the electrical leads.

Preferably, the electrical lead is surrounded by an insulator preferably a ceramic insulator. By the insulator a direct contact between the electrical lead and the anode is possible and the electrical lead can be arranged in direct contact with the anode without creating shorts.

Preferably, the electrical lead has at least two electrical lines. In particular, since with the electrical lead a heating element of the NEG module can be connected, two electrical lines are necessary. Therein, each electrical line may be surrounded by an insulator, preferably a ceramic insulator.

Preferably, the anode of the SIP module has at least one or more indentations, wherein the electrical lead is arranged in the indentation. Therein, in particular the number of indentations is equal to the number of electrical lines of the electrical lead. By the indentations the electrical lead can be placed closer to the anode preventing a direct line of sight between the electrical lead and the cathode of the SIP module. At the same time structural stability of the electrical lead is enhanced. This is imported in particular if the electrical lead is surrounded by a ceramic insulator which is brittle and there is a need for stabilizing the ceramic insulator structurally.

Preferably, an outer structure of the SIP module and/or an outer structure of the NEG module are cylindrical. Therein for the SIP module the outer structure might be provided by the shell having a cylindrical shape. The outer structure may be a housing which may or may not vacuum tight. The housing may render the SIP module and/or the NEG module fully functional and preferably provides means for connecting the vacuum pump to a vacuum apparatus or chamber. Alternatively, the outer structure is surrounding the elements of the SIP module and/or the NEG module and built to be inserted in a vacuum apparatus or chamber. Therein, the outer structure may comprise openings to allow gas to enter into the SIP module or NEG module.

Preferably, the outer surface of the SIP module and the outer surface of the NEG module, in particular of the respective outer structures, flushes with each other providing an overall cylindrical shape of the vacuum pump.

Preferably, the vacuum pump comprises a flange wherein the SIP module is connected with its first end to the flange and preferably with its second end to the NEG module. In particular the SIP module is directly connected by a base element to the flange and the NEG module is connected to the SIP module via a top element of the SIP module. Alternatively, the base element may be a flange to connect the SIP module/NEG module to a vacuum apparatus or vacuum chamber.

Preferably, the SIP module and the NEG module are arranged within an area of the flange. Thus, the SIP module and the NEG module can be together inserted into a vacuum chamber and fixed to the vacuum chamber by the flange.

Preferably, the NEG module and the SIP module are completely arranged within the vacuum. In particular, due to the small building size of the NEG module and the SIP module, both can be inserted into a vacuum chamber and connected to the vacuum chamber by a flange. Thus, no additional volume of vacuum space is added to the vacuum chamber the vacuum pump is installed on. At the same time due to the present invention the number of parts in the vacuum is reduced relative to if a standard ion pump design were modified in order to be mounted to a flange.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

In the following the present invention is described in more detail with reference to the accompanying figures. The figures show:

FIG. 1 a vacuum pump according to the present invention,

FIG. 2 a sectional view of the vacuum pump of FIG. 1,

FIG. 3 a frame structure of the vacuum pump of FIG. 1,

FIGS. 4A and 4B the frame structure and an anode of the vacuum pump of FIG. 1,

FIGS. 5A-5C a shell element of the vacuum pump of FIG. 1,

FIGS. 6A and 6B a sectional view of a non-evaporable getter module,

FIG. 7 a connecting element according to the present invention,

FIGS. 8A and 8B insulation elements according to the present invention,

FIG. 9 a sectional view of the SIP module according to FIG. 1.

### DETAILED DESCRIPTION

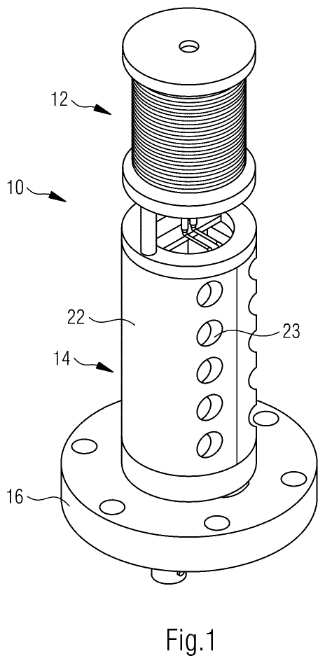

Referring to FIG. 1 showing a vacuum pump 10 according to the present invention. Therein the vacuum pump 10 comprises a non-evaporable getter (NEG) module 12, a sputter ion pump (SIP) module 14 and a vacuum flange 16. Therein the SIP module 14 is directly connected to the flange 16, wherein the NEG module 12 is attached to the SIP module 14 opposite to the flange 16. The vacuum pump 10 and in particular both the NEG module 12 and the SIP module 14 have a cylindric shape. The shape of the SIP module 14 flushes with the shape of the NEG module 12 such that the SIP module 14 and the NEG module 12 may have a substantially similar or identical outer shape or at last cross-section. Although in the following figures the vacuum pump has a cylindrical shape, other shapes are also possible.

The NEG module 12 and the SIP module 14 are arranged within the area of the flange 16 and can be completely inserted into a vacuum chamber for pumping.

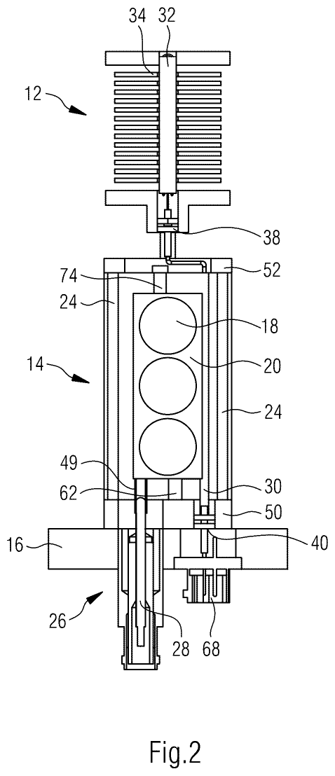

Referring to FIG. 2. In the section view it is shown that the SIP module 14 comprises an anode 20 which has in the example of FIG. 2 three cylindrically shaped openings or tubes. Other numbers of tubes are also possible. At an axial end of these openings a cathode 18 is disposed. The anode 20 is kept on a high electrical potential by a high voltage (HV) conductor 28 guided through the flange by a vacuum feedthrough 26 and connected to the anode. Furthermore, the flange 16 comprises a connector 68 which is connected via an electrical lead 30 with a heating element 32 of the NEG module 12. NEG elements 34 are arranged onto the heating element 32 for re-activation of the NEG material by heating up.

Here and in the following the axial direction of the SIP and its element is defined along the anode from its lower side to its upper side. Here and in the following, the lateral direction refers to a direction perpendicular to the axial direction of the anode.

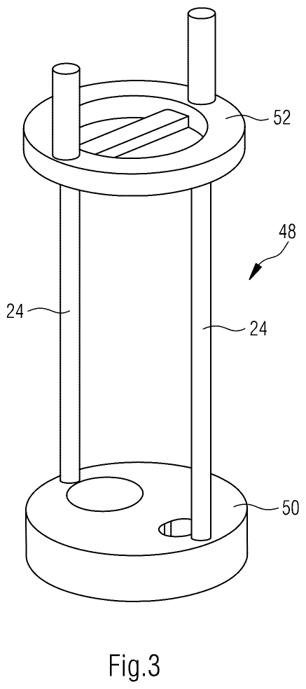

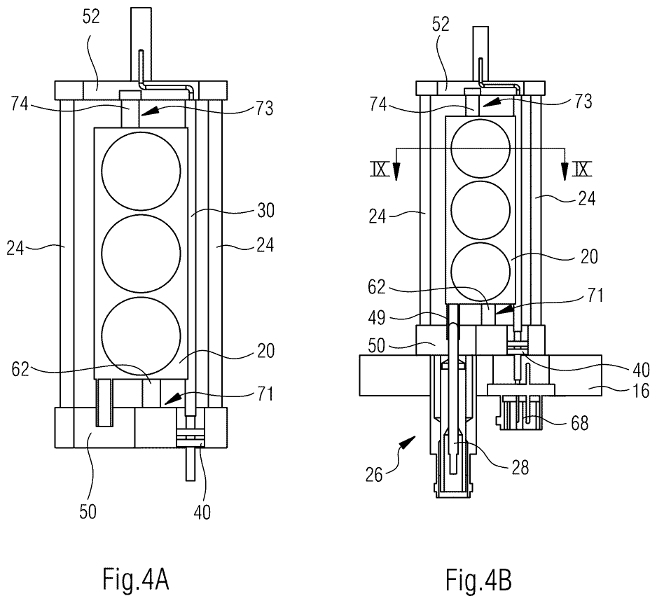

Referring to FIG. 3 showing the frame structure 48 of the SIP module. The frame structure 48 comprises a base element 50 which can be attached to the flange 16 by welding, brazing, soldering, screws or any other releasable connection means. In other embodiments the flange 16 and the base 50 are integrally built or the base element 50 may be provided by the flange 16 itself. Connected to the base element 50 are in the example of FIG. 3 two frame side elements 24 built as shoulder screws or posts which extend from the base element 50 to a top element 52. The NEG module 12 can be connected to the top element 52 by welding, brazing, soldering, screws or any other releasable connection means. During assembly, the anode 20 is fixed within the frame structure 48 and subsequently the frame structure 48 together with the anode 20 is connected to the flange 16. This is shown in FIGS. 4A and 4B. The anode 20 is connected in the frame structure 48 by a lower support element 71 provided by an insulating element 62 connected to the anode 20. Further, an upper support element 73 is provided by an insulating element 74. Therein, the insulating elements 62, 74 are built by an insulating material such as a ceramic material. By the lower insulating support 71 the anode 20 is restricted from downward motion towards the flange 16 and might also be restricted by lateral motion, i.e. in one or more other directions or all other directions. By the upper support element 73, the anode 20 is restricted from upward motion and lateral motion, i.e. in one or more other directions or all other directions. The at least one support element 71, 73 or the two support elements 71, 73 may not fully restrict lateral movement allowing slight lateral movement of the anode while connecting the anode to the HV conductor 28 in order to facilitate mounting the HV conductor 28 to the anode 20. Thus, a secure connection between the HV conductor 28 and the anode 20 is possible and slight manufacturing deviations can be compensated for. In order to prevent motion of the anode 20 completely and fix the anode's position in the frame structure, the anode 20 is connected to the HV conductor 28, extending through an opening in the base element 50, via a conducting sleeve 49, connecting the anode 20 with the HV conductor 28 of the vacuum feedthrough 26. Thus, by the lower support element 71, the upper support element 73 and the connection to the HV conductor 28 of the electrical feedthrough 26, the anode 20 is fixed in its position within the frame structure 48 of the SIP module 14.

The steps for assembling the SIP module 14 thus comprise:
a) providing a frame structure preferably comprising base element 50, one or more frame side elements 24 connected to the base element, and may also include a top element 52 connected to the respective frame side elements 24,
b) inserting the anode and connecting the anode in the frame structure by the lower support element 71 and the upper support element 73,
c) attaching the frame structure 48 together with the anode 20 to the flange 16, thereby connecting the anode 20 to the electrical feedthrough 26 and simultaneously fixing the position of the anode 20 in the SIP module 14,
d) attaching the shell around the frame structure 48 as explained in more detail below.

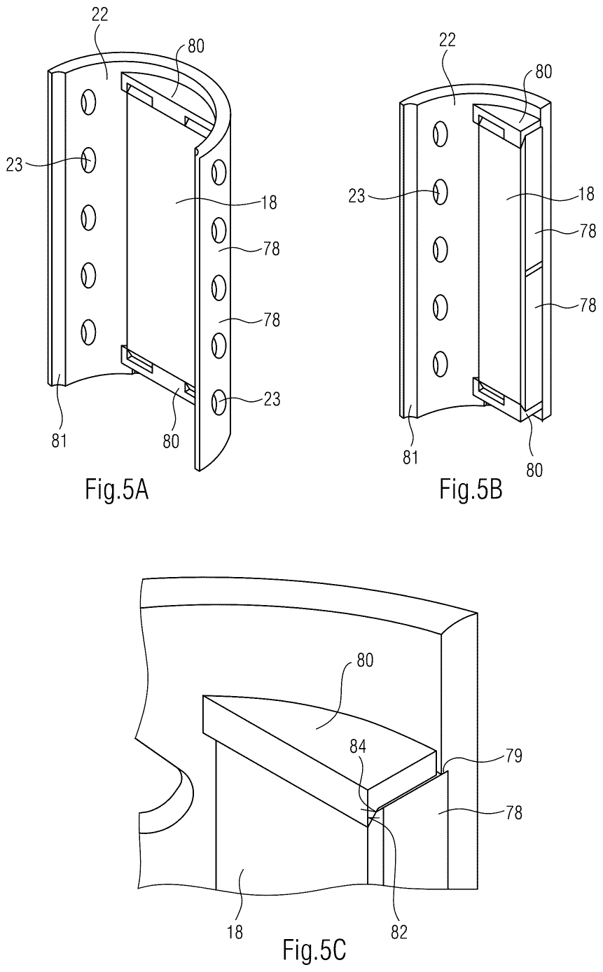

Referring to the FIGS. 5A-5C showing details of the shell of the vacuum pump 10. The shell of the vacuum pump 10 and in particular of the SIP module 14 comprises two individual shell elements 22. Therein, each shell element 22 is built identically in the present embodiment but the shell elements 22 may also be built/designed differently. Each shell element 22 comprises at least one magnet 78, wherein in the example of FIGS. 5A-5C each shell element 22 comprises two magnets 78. Therein, the magnets 78 are arranged in a recession 79 of the shell element 22 in order to prevent lateral movement. The size of the recession 79 is adapted to the size of the magnets such that sidewalls of the recession 79 directly contact sidewalls of the respective magnets 78. The magnets 78 are attached to the respective shell elements 22 only by their magnetic force. No further fixing/fastening elements are present. Thus, the shell elements 22 serve as both pole pieces and the outer structure for the SIP module 14. The pole pieces guide the magnetic flux through the SIP module 14, and the outer structure provides structural stability to the SIP module 14. Therefore, the shell elements 22 are made from a magnetic material such as mild steel. The magnets 78 are neodymium (Nd) magnets or samarium (Sa) cobalt (Co) magnets. The magnets are attached with one surface to the shell element 22. An opposite surface of the magnets 78 is directly connected to the cathode 18. The cathode 18 is plate-shaped and covers the complete or substantially complete surface of the magnets 78. The cathode 18 may be made from titanium (Ti) or tantalum (Ta). The two shell elements 22 may comprise cathode elements 18, 18′ made from the same material or different material. In order to fix the cathode 18 in its position, bracket or clamping elements 80 are provided at the upper end and lower end of the respective magnets 78. The bracket elements 80 are held in place by the magnetic force of the magnets 78. No additional fixing elements are necessary. The bracket elements 80 comprise a chamfered surface 84 with a chamfer towards the magnets 78. Similarly, the cathode element 18 comprises chamfered edges 82 with a chamfer facing away from the magnets 78 and corresponding to the chamfered surface 84 of the bracket elements 80. When attaching the bracket element 80 to the side of the magnets 78, a clamping force is applied to the cathode 18 to fix the position of the cathode 18. The surface of the cathode element 18 flushes with the respective bracket element 80 and thus close positioning of the cathode element 18 to the anode 20 is feasible. Further, assembly and disassembly of the cathode elements 18 can be done without the need of additional tools.

The two shell elements 22 resemble the outer shape of the SIP module 14. The shell elements 22 have openings 23 to allow gas molecules and particles to enter the active volume of the SIP module. The present invention is not limited by the number or shape of these openings 23 .. In order to have sufficient stability of the shell elements, the shell elements 22 provide at their axial edge an indentation 81 along an axial direction of the shell elements 22 which accommodates the frame side elements 24 when attached to them. Thus, by the corresponding shape of the indentations 81, the position of the elements 22 are defined by the position of the frame side elements 24.

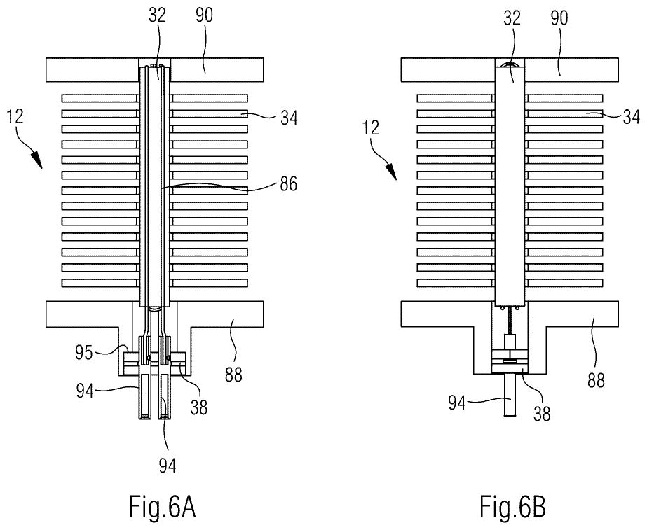

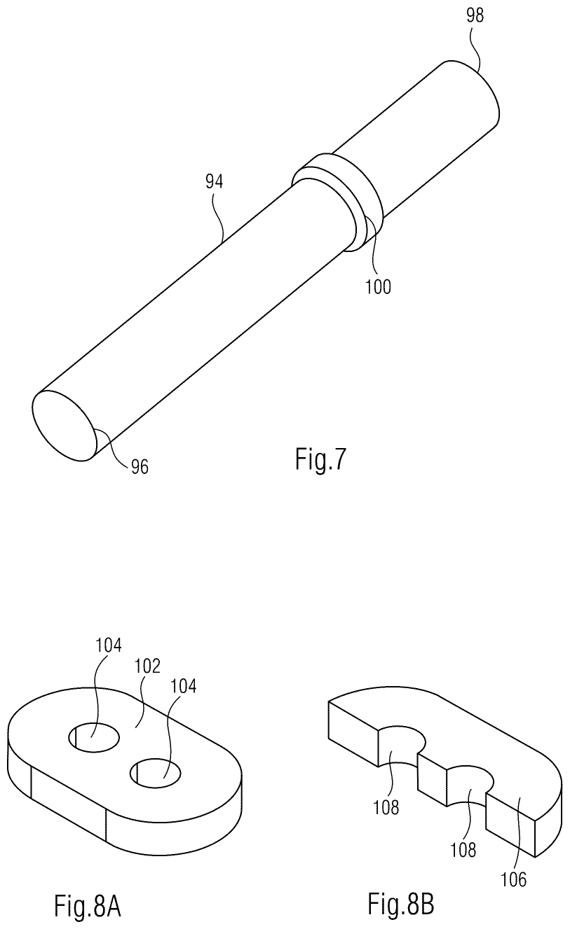

Referring to FIGS. 6A and 6B showing the NEG module 12 comprising a heater 32 with heating wire 86. The NEG module 12 comprises a base element 88 and top element 90, wherein NEG elements 34 are sleeved over the heater 32. The top element 90 and the base element 88 might be connected by NEG side elements such as shoulder screws or posts. In particular the NEG side elements are built by threaded rods or posts. The electrical connection of the heater 32 is provided by an electrical connector 38 having connection elements 94. The connection elements 94 are shown in more detail in FIG. 7. The connection elements 94 comprise a first end 96 and second end 98. Between the first end 96 and the second end 98 a collar or protruding feature 100 is present. Although shown in FIG. 7 that the first end 96 and the second end 98 may have the same diameter, the present invention is not limited to this example and also different diameters of the first end 96 and the second end 98 would be possible. Similarly, the example of FIG. 7 shows a circular cross section wherein other shapes are of course also possible.

The connector 38 comprises insulating elements 102, 106 as shown in FIGS. 8A and 8B. A first insulating element 102 has openings 104. Therein the number of openings 104 corresponds to the number of connecting elements 94. The diameter of the openings 104 corresponds to the diameter of the first end 96 and preferably the insulating elements 102 is made from a ceramic material. Similarly, the second insulating element 106 is made from a ceramic material. The second insulating element 106 is built by two halves, wherein FIG. 8B shows only a single halve. By the two halves of the insulating element 106 openings 108 are established, wherein the diameter of the openings 108 correspond to the diameter of the second end 98 of the connecting element 94. The connecting element 94 is crimped or otherwise attached to the heating wire 86 of the heater 32. Subsequently the two halves of the second insulating element are inserted into a housing of the base element 88 of the NEG module 12 and sits on a shoulder 95. Therein, due to the protruding feature 100, the connecting elements 94 cannot fall through the openings 108 of the second insulating element 106. Subsequently, the first insulating element 102 is assembled by inserting the first end 96 of the connecting elements 94 into the respective openings 104. Due to the protruding feature 100, the connecting elements 94 cannot fall out of the first insulating element 102. By a fixing element, for example provided by a set screw, the first insulating element 102 and the second insulating element 106 are fixed in their position. Thereby, no clamping force is directly acting on the connecting elements 94. Due to the protruding feature 100, the fixing element 94 is fixed in its axial position wherein a slight lateral movement of the connecting element 94 is still allowed and helps during assembly of the NEG module 12.

Similar to the connector 38 connecting the NEG module 12 to the SIP module 14, a connector 40 is provided in order to connect the SIP module to the flange 16 as shown in FIGS. 4A and 4B. Thereby, an electrical lead 30 to be connected to the heater 32 runs from the flange 16 through the complete SIP module 14 and via the connector 38 to the NEG module 12. The electric lead 30 may comprise two electrical wires 110, 110′ which are surrounded by an insulating material such as a ceramic material.

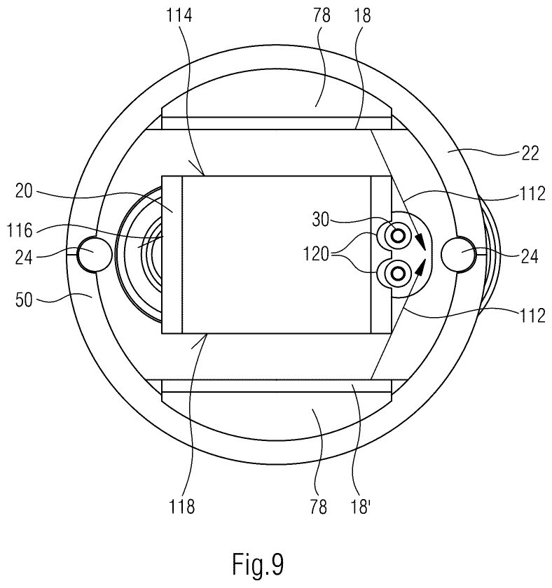

In the following it is referred to FIG. 9 showing a sectional top view of the SIP module 14. The anode 20 has a first surface 114 and an opposite second surface 118, which correspond to the axial direction of the cylindric openings in the anode 20. The first surface 114 and the second surface 118 are connected by side surfaces 116, wherein the electrical lead 30 runs along a side surface 116 of the anode 20. Due to the position of the electrical lead 30, there is no direct line or line of sight 112 between the cathode element 18 and the electrical lead 30 preventing or at least reducing the likelihood of sputtering material of the cathode 18 onto the surface of the electrical lead 30 which may produce shorts. Thus, the electric lead 30 is protected by the anode 20 itself. Therefore, the side surface 116 of the anode may comprise indentations 120 which accommodate the electrical lead 30 and the respective wires 110, 110′ of the electrical lead 30. Thus, the low voltage supply of the heater 32 of the NEG module 12 is running from the connector 68 via the connecting element 40 and the electrical lead 30 across the SIP module 14 and in particular within the pole pieces of the SIP module provided by the shell elements 22 towards the connector 38 at the top element 52 of the SIP module and then further to the connector 38 and the heater 32.

Thus, by the vacuum pump according to the present invention a combination of an NEG module and an SIP module is provided which can both be completely inserted into the vacuum chamber having a small cross-sectional area. At the same time, due to implementing a frame structure 48 and a shell, the process of assembling the SIP module 14 is simplified and the number of necessary parts in the vacuum can be reduced.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump comprising:
a sputter ion pump, SIP, module, having a first end and a second end;
a non-evaporable getter, NEG, module, connected to the second end of the SIP module;
an electrical lead of the NEG module running from the first end to the second end of the SIP module;
wherein the SIP module comprises an anode having a first surface and an opposite second surface, wherein at least one cylindric opening extends from the first surface to the second surface, wherein the anode further comprises side surfaces extending from the first surface to the second surface,
wherein the electrical lead is arranged at the side surface of the anode.

2. The vacuum pump according to claim 1, wherein no line of sight exists between a cathode of the SIP module and the electrical lead and in particular between the anode's projection onto the cathode and the electrical lead.

3. The vacuum pump according to claim 1, wherein the anode of the SIP module blocks a direct line between the cathode and the electrical lead.

4. The vacuum pump according to claim 1, wherein an anode of the SIP module has a width of between 10 mm and 50 mm, more preferably between 15 mm and 30 mm and most preferably between 15 mm and 20 mm.

5. The vacuum pump according to claim 1, wherein the electrical lead is arranged within the SIP module.

6. The vacuum pump according to claim 1, wherein electrical lead is surrounded by an insulator preferably a ceramic insulator.

7. The vacuum pump according to claim 1, wherein the electrical lead has at least two electrical lines.

8. The vacuum pump according to claim 1, wherein an anode of the SIP module has at least one or more indentations, wherein the electrical lead is arranged in the indentations.

9. The vacuum pump according to claim 1, wherein an outer structure of the SIP module and/or an outer structure of the NEG module are cylindrical.

10. The vacuum pump according to claim 1, wherein an outer surface of the SIP module and outer surface of the NEG module flushes with each other.

11. The vacuum pump according to claim 1, comprising a flange, wherein the SIP module is connected with its first end to the flange, and/or wherein the NEG module and the SIP module are arranged within an area of a flange.

12. The vacuum pump according to claim 1, wherein the NEG module and/or the SIP module are completely arranged within the vacuum.
